(19) United States
(12) Patent Application Publication
(10) Pub. No.: US 2011/0071846 A1
(43) Pub. Date: Mar. 24, 2011

(54) HEALTHCARE PROCESSING SYSTEM AND METHOD

(75) Inventors: Douglas Crystal, Chagrin Falls, OH (US); Joseph F. Turi, Wickliffe, OH (US); Pamela S. Priddy, Newton Falls, OH (US)

(73) Assignee: MyriadHealth, LLC, Chagrin Falls, OH (US)

(21) Appl. No.: 12/945,136

(22) Filed: Nov. 12, 2010

Related U.S. Application Data
(63) Continuation of application No. 11/535,832, filed on Sep. 27, 2006, now abandoned.

(51) Int. Cl. G06Q 50/00; G06Q 10/00

(52) U.S. Cl. 705/2

(57) ABSTRACT

A method for processing and tracking a health care transaction is disclosed herein. In one embodiment, the method includes steps of receiving data related to a health care transaction and applying rules to eliminate downstream options. After the rules are applied, a transaction is built based in part on the received data and on the applied rules. Next, the transaction is stored and sent to a transaction layer for further processing. In one embodiment, a unique identifier is assigned to the data for tracking.

### RELATED APPLICATIONS

This non-provisional application claims the benefit of U.S. Provisional Application No. 60/721,380 filed Sep. 27, 2005 incorporated herein by reference.

### BACKGROUND

There are no systems or methods that can provide complete seamless claim entry at a provider's office, link to an adjudication process, and pay any claim fees due for a transaction in near real time. In addition, Federal and local regulations increasingly place restrictions on use, access, and disclosure of patient information.

U.S. Patent Publication No. 2003/0200118 to Lee et al. describes a system that allows a health care provider to arrange payment at the time of service for a co-payment of a health care claim amount, even though the provider may not know what the co-payment will be until after adjudication. A health care debit card is associated with an account of the patient. At the time of service, the patient presents the card to the provider. The provider uses the card to authorize the system to hold an estimate of the co-payment amount in suspense in the patient's account. After adjudication, when the actual co-payment amount is known, a transaction set is sent to the system. The system then automatically transfers the actual co-payment amount from the patient's account and into the provider's bank account. Any remainder of the suspended funds is left in the patient's account. A trace number is provided so that the provider can reconcile bank statement deposits with transaction set information.

U.S. Patent Publication No. 2005/0121517 to Igval et al. describes systems and methods for providing track and trace capabilities for checks in a mail stream and in a bank check clearing system. A mailing machine facilitates the association of a confirmation tracking number with a mail piece and a check. The track and trace system provides for tracking the check through the mail stream and also through the bank check clearing system using the confirmation tracking number.

U.S. Pat. No. 5,890,129 to Spurgeon describes an information-exchange system for controlling the exchange of business and clinical information between an insurer and multiple health care providers. The system includes an information-exchange computer that is connected over a local area network to an insurer computer using a proprietary database and over the Internet to health-care provider computers using open database-compliant databases. The information-exchange computer receives subscriber insurance data from the insurance computer database, translates the insurance data into an exchange database, and pushes the subscriber insurance data out over the Internet to the computer operated by the health-care provider assigned to each subscriber. The information-exchange system stores the data in the provider database. The information-exchange system also provides for the preparation, submission, processing, and payment of claims over the local area network and over the Internet. In addition, prior authorization requests may be initiated in the provider computers and exchanged over the information-exchange system for review by the insurer computer. Processed reviews are transmitted back to the provider computer and to a specialist computer, if required, using push technology over the Internet.

U.S. Patent Publication No. 2003/0177033 to Park et al. describes an Internet based electronic prescription system and method thereof which may rapidly and accurately transmit the electronic medical record including prescription etc. of patient treatment issued by first doctor to other doctors or pharmacists, and connect to the advertising system of pharmaceutical company. The system includes a pharmacy database system, a group server of the pharmaceutical company, a Web server, and a terminal computer group (KIOSK) for payment of medical examination.

U.S. Patent Publication No. 2004/0153369 to Bencak describes a method of carrying out business transactions via the Internet. A server computer system receives a request for an article from a first client computer system and shows certain information from the customer's request on a first web page. A vendor authorized to access this first web page replies to the request and sends the reply to the server computer system. The server computer system sends an e-mail with the data from the vendor's reply to the customer.

### BRIEF DESCRIPTION OF THE DRAWINGS

The accompanying drawings, which are incorporated in and constitute a part of the specification, illustrate various example systems, methods, and so on of embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a network for healthcare transaction processing and data tracking.

FIG. 2 illustrates one embodiment of a healthcare transaction processing and tracking system;

FIG. 3 is a table of exemplary users of the healthcare transaction processing and tracking system;

FIG. 4 illustrates one embodiment of a method of processing a healthcare transaction;

FIG. 5 is a table of exemplary transactions that may be processed or tracked in the healthcare processing and tracking system;

FIG. 6 is a table of exemplary rules that may be applied in processing a healthcare transaction;

FIGS. 7A-7B illustrate one embodiment of a method of processing a healthcare transaction;

FIGS. 8A-8C illustrate an alternative embodiment of a method of processing a healthcare transaction;

FIG. 9 illustrates exemplary fields and data that may be used in a healthcare transaction;

FIG. 10 illustrates one embodiment of a method for tracking healthcare transaction data; and

FIG. 11 illustrates one embodiment of a structural hierarchy of authorization levels for viewing healthcare transaction data.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer-readable medium,” as used herein, refers to a medium that participates directly or indirectly in providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like those generated during radio-wave and infra-red data communications, or take the form of one or more groups of signals. Common forms of a computer-readable medium include, but are not limited to, an ASIC, a compact disc (CD), a digital video disk (DVD), a random access memory (RAM), a read only memory (ROM), a programmable read only memory (PROM), an electronically erasable programmable read only memory (EEPROM), a disk, a carrier wave, a memory stick, a floppy disk, a flexible disk, a hard disk, a magnetic tape, other magnetic media, a CD-ROM, other optical media, punch cards, paper tape, other physical media with patterns of holes, an EPROM, a FLASH-EPROM, or other memory chip or card, and other media from which a computer, a processor or other electronic device can read. Signals used to propagate instructions or other software over a network, like the Internet, can be considered a “computer-readable medium.”

“Logic,” as used herein, includes but is not limited to hardware and firmware, optionally with embedded software, and/or combinations of each to perform a function(s) or an action(s), and/or to cause a function or action from another component. For example, based on a desired application or needs, logic may include a software controlled microprocessor, discrete logic like an ASIC, a PLD, a memory device containing instructions, or the like. A logic may be implemented as a chipset.

An “operable connection,” or entities which are “operably connected,” is a connection in which signals, physical communication flow, and/or logical communication flow may be sent and/or received. Typically, an operable connection includes a physical interface, an electrical interface, and/or a data interface. However, an operable connection may include any combination of these or other types of connections sufficient to allow operable control.

“Signal,” as used herein, includes but is not limited to one or more electrical or optical signals, analog or digital, one or more computer or processor instructions, messages, a bit or bit stream, or other means that can be received, transmitted and/or detected.

“Software,” as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may depend on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, machine, firmware, microcode, and/or other languages and tools. Software, whether an entire system or a component of a system, may be embodied as an article of manufacture and maintained as part of a computer-readable medium as defined previously. Another form of the software may include signals that transmit program code of the software to a recipient over a network or other communication medium.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

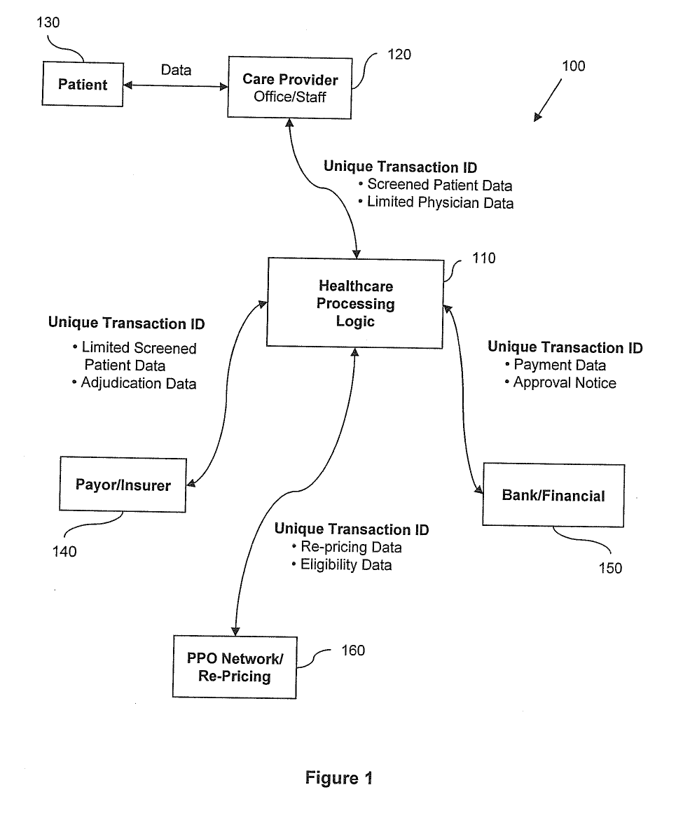

With reference now to FIG. 1, an exemplary healthcare system 100 is shown. The system includes health care processing logic 110 that links a care providers 120, patients 130, insurers and payors 140, banks and financial institutions 150, and PPO Networks and other re-pricing institutions 160. The parties may be linked to the health care processing logic 110 by a network such as an LAN, a WAN, the Internet, a wireless network, or any known mobile or telecommunications network of computing devices, including handheld devices. An individual may access the health care processing logic 110 by providing a unique transaction ID. Care providers 120 and patients 130 may use the health care processing logic 110 to enter or retrieve patient or physician data. Insurers 140 may enter or retrieve patient data, adjudication data, and payment data. Banks 150 may enter or retrieve payment data and approval notices. PPO networks and re-pricing institutions 160 may enter or retrieve re-pricing data and eligibility data.

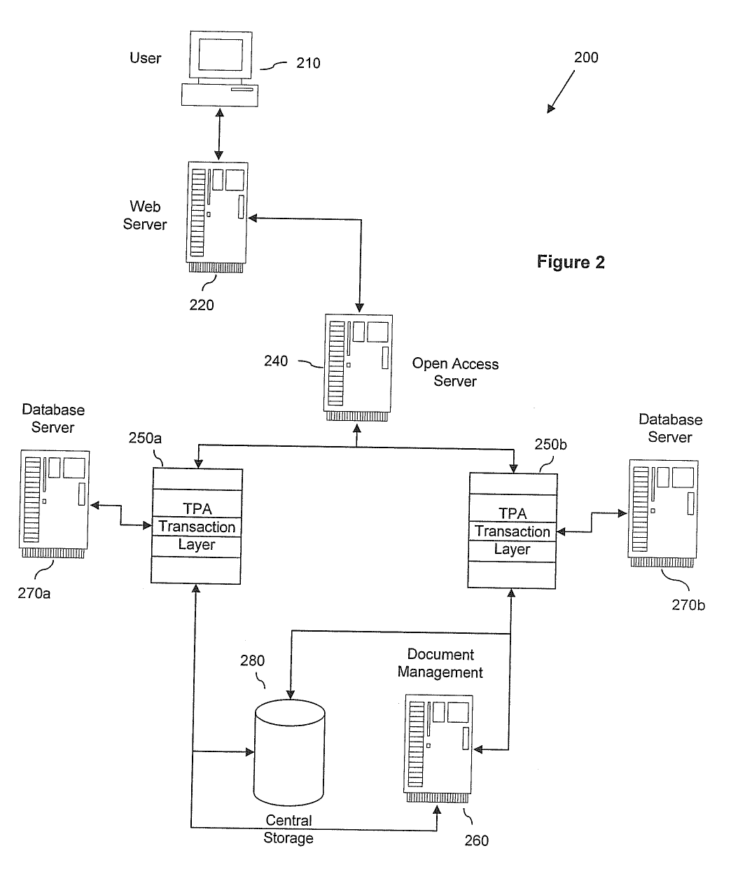

Turning now to FIG. 2, an exemplary healthcare transaction processing system 200 is shown. A user 210 operating a terminal, accesses a web server 220 to initiate, for example a transaction. The user 210 may be in data communication with the web server 220 by a network such as an LAN, a WAN, the Internet, a wireless network, or any known mobile or telecommunications network of computing devices, including handheld devices. The user enters data related to the transaction. The transaction may include, without limitation, a claim, a referral, a pre-certification, a pre-authorization, an informational request via an explanation of benefits (EOB), a report, a Health Care Financing Administration (HCFA) form, and the like. The server 220 is in data communication with an open access server 240. The open access server 240, is operably connected to one or more third party administrator (TPA) transaction layers 250a, 250b to process transactions. Although two TPA layers are shown, it should be understood that any number of TPA layers may be operably connected to the open access server 240.

TPA transaction layers 250a, 250b periodically receive transaction data and logic commences validation, applies network rules, and adjudicates the transaction. During the transaction layer processing, transaction documents may be created, stored through data communication channels with document management server 260, or distributed for approval and subsequent processing. The transaction layers 250a, 250b also maintain a data communication channels with respective database servers 270a, 270b, where TPA data, for example, may be stored. Upon completion of a transaction, confidentiality compliant details may be stored in a separate central storage database 280. It should be appreciated that multiple transaction layers 250a, 250b and databases 270a, 270b may be provided for different TPA's for example, to maintain isolation and confidentiality of individual medical and financial data.

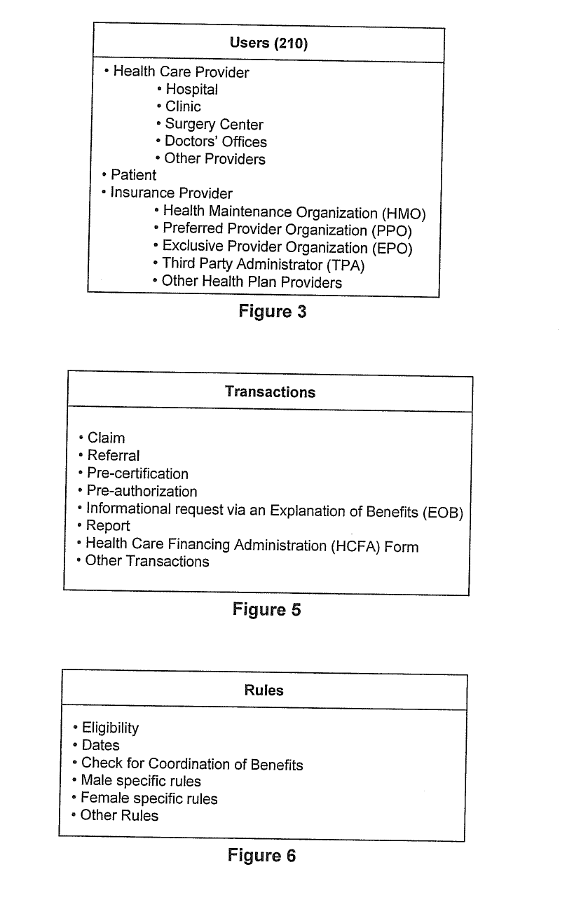

As shown in FIG. 3, the user terminal 210 may be located, for example, at one of a health care provider, a patient home or office, or an insurance provider. Health care providers include hospitals, clinics, doctors' offices, surgery centers, and other known providers. Patients include individuals and dependants. Insurance providers include Health Maintenance Organizations (HMOs), Preferred Provider Organizations (PPOs), Exclusive Provider Organizations (EPOs), other TPAs, and other known health plan providers.

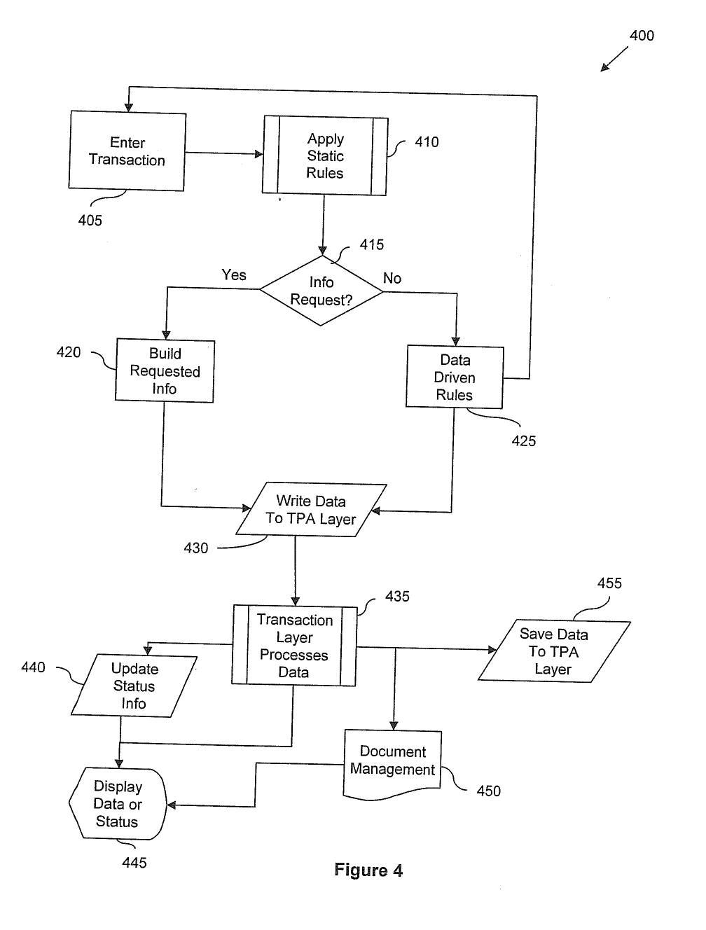

With reference now to FIG. 4, an exemplary method may begin with a user entering data related to a health care transaction, step 405. As shown in FIG. 5, the system can be used to process and track any number of healthcare transactions, including without limitation a claim, a referral, a pre-certification, a pre-authorization, an informational request via an explanation of benefits (EOB), a report, a Health Care Financing Administration (HCFA) form, and the like.

Once the transaction is entered, a static rule or group of rules may be applied, step 410, to permit or prevent various downstream options based on the transaction entered, or based on data corresponding to the transaction. As shown in FIG. 6, any number of rules can be employed to streamline the process. For example, if a claim is entered for a male, no female related codes will appear throughout the process. Other rule implementations include checking eligibility rules, date rules, Coordination of Benefits (COB), and the like. Further, if a unique transaction identifier is not yet established, one of the rules may generate and/or assign such an identifier for transaction tracking throughout the system.

At step 415, if further information is needed, a request for information is built, step 420. If no further information is required, data driven rules are applied, step 425. Each type of transaction, such as a claim, a pre-authorization, a pre-certification, a request for a report, or a request for an EOB, has a specific set of data driven rules. After the build or the rules are applied, data may be written to the database, step 430.

The data may then be further transmitted to a TPA layer for processing, step 435. The TPA layer may be a remote transaction layer. The data may be pulled or pushed from a database after step 430, or it may proceed directly to the layer without an intermediate stop.

Once the data is obtained by the TPA layer, the status of the transaction may be stored for later access, audit, and/or analysis, step 440. Further, as the TPA layer processes the transaction, the status will periodically be updated. As will be further explained below, in one embodiment, the status of the transaction may be tracked through the life of the transaction and/or throughout the method and system by a unique identifier established upon transaction entry, at step 405, or shortly thereafter. The status information at step 440 may be displayed to authenticated persons, at step 445, and documents, preferably electronic documents, relating to the transaction may be viewed and/or manipulated, if permitted, at step 450. Additionally, the TPA layer may save the data to its own database, step 455.

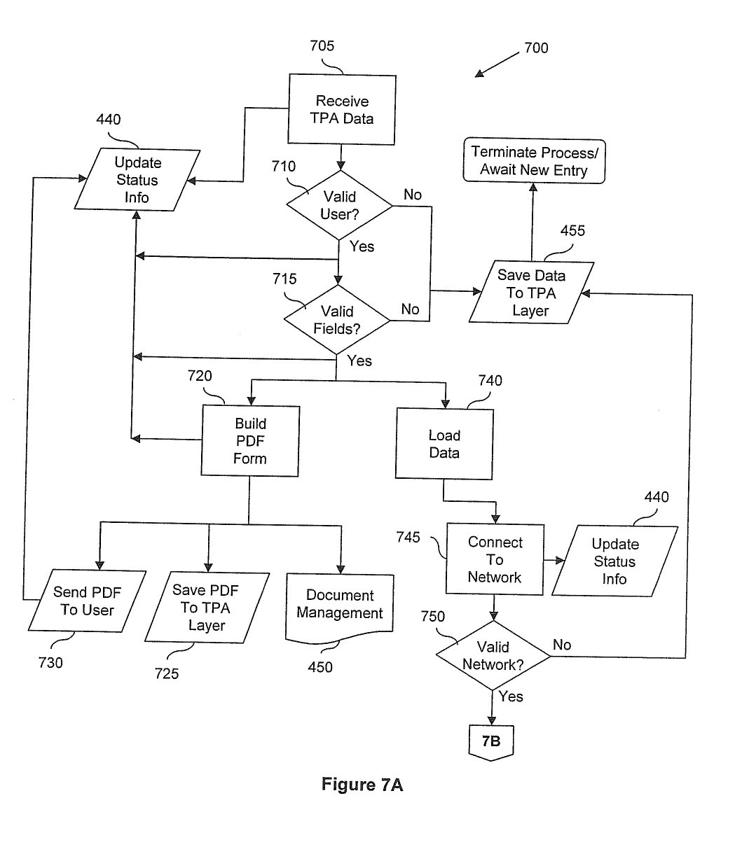

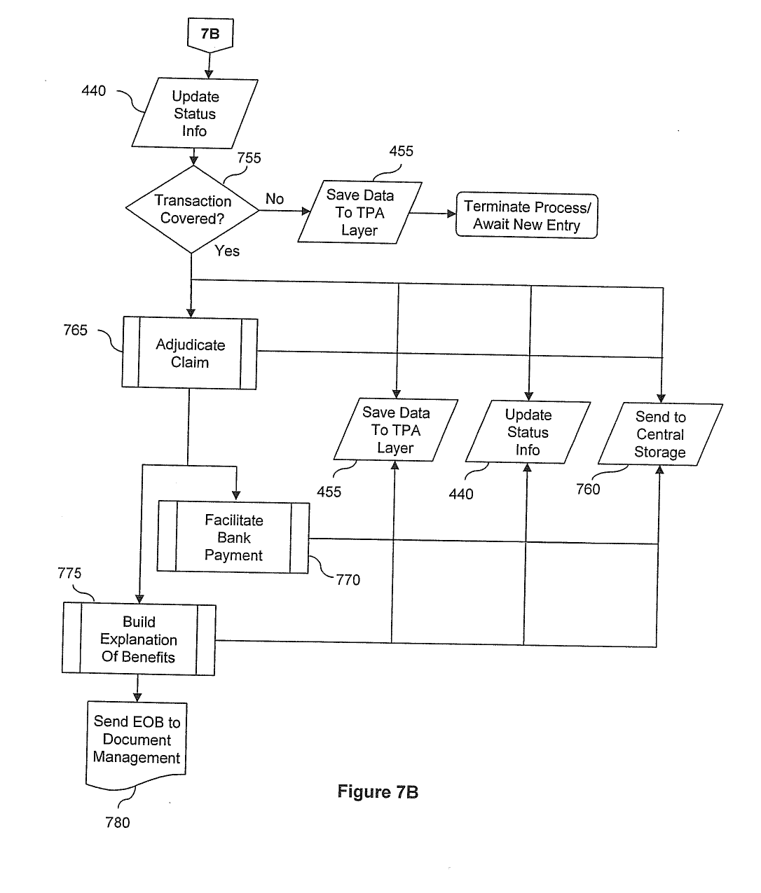

FIGS. 7A-7B illustrate the transaction processing method 700 performed by the TPA layer. The processing method begins with the receipt of transaction data, step 705. As explained above, the transaction data may be pushed or pulled from a database (for example, from the TPA layer), or may be directly transmitted by a user. Once the data is received, a validation process may occur to ensure that a valid user wrote the transaction, step 710. For example, if an attempt was made to submit a claim without knowing a valid code identifying a valid user, the transaction would be rejected the at this point. After rejection, the data may be optionally saved to the TPA layer. The layer may have a portion of memory reserved for “bad claims,” for later analysis. If the user is valid, the status is updated, step 440, and the method continues.

An additional or alternative validation step may include verification that all proper fields are populated and include valid entries, step 715. For example, a transaction may be considered invalid if any required field is missing data, or contains corrupt data. If the transaction is invalid, the data may be optionally saved to the TPA layer for later analysis. If the transaction is validated, the transaction is processed.

The layer may then produce desired documents relating to the verified data. For example the method may build or generate forms, such as HCFA forms, step 720. Such forms may be embodied in any suitable format now known or later created. For illustration purposes, such forms are described as PDF forms. Any forms generated may include the unique identifier for later retrieval or analysis. After the PDF form is generated, it may then be written into the database and put into a binary format in the database which may be encrypted, step 725. The document may also be sent to the user, step 730. The document may also be stored in the front end document management database, step 450 and/or stored in a backend database.

The layer may also update the status table, step 440, after each step or after several steps. For example, as the transaction or TPA layer grabs the data, step 430, it writes to the status table, step 440. As it validates the user, step 710, it writes to the status table, step 440. As it validates all required fields, step 715, it writes to the status table, step 440. As it writes to the TPA, it writes to the status table, step 440. As it builds the PDF, step 720, it writes to the status table, step 440. As it stores the PDF, step 725, it writes to the status table, step 440. As it writes to the data and the document management, step 450, it stores to the status table, step 440. Periodic updates of the status table may be used to track and display a transaction's progress.

After validation, the layer may also load the transaction data, step 740 and connect to a network, step 745. For example, in a PPO network, the layer is actually in communication with the network's data (not shown). After the network connection is made, the status table is once again updated, step 440. The communication may involve certain acceptable charges for a procedure associated with the transaction where the charges, the procedure or both may be farther associated with the unique transaction identifier. In other words, the TPA may incur the charge for the procedure, or if the network already has a discount arrangement for that procedure or with the associated provider.

After connecting to the network, the network is validated, step 750. If the network is not valid or does not cover the transaction, step 755, the status table is updated, step 440, and the method may stop or notify the user for remedial attention (not shown). The data may also be stored to the TPA layer or a related database for later analysis. Alternately, or if the network is valid, step 750, and the transaction is covered, step 755, the transaction process may continue, as illustrated in FIG. 7B. Further, if the network is valid, step 750, and the transaction is covered, step 755, the status table may be updated, step 440, and data may be written to the TPA layer, step 455, and/or stored in a central database, step 760.

As illustrated in FIG. 7B, after network validation, any claims are adjudicated, step 765. Adjudication may be the calculation of what payment, if any, is required from each of the potentially responsible payers. In other words, what is the plan provider responsible for, what is the employee responsible for, what is denied, what co-pay is required, what deductible applies, and the like. What dollar amount will be payable to the provider, and how does the schedule of benefits apply to the transaction. The step of claim adjudication may be performed by applying data rules related to claim data, eligibility data, subrogation triggers, and items that may require manual interaction. For example, in the case of an automobile accident claim, certain official reports may be required.

In one embodiment, a schedule of benefits is available to the provider to enable the provider to know in an office visit setting if a co-pay, as an example, is due, or if full coverage, or a deductible applies and so forth. Upon adjudication of the claims, the layer may update the status of the transaction associated with the unique identifier at the TPA layer, step 455, a central database, step 760, and the status table, step 440.

With the transaction fees known, the layer may then complete the transaction by facilitating bank payment, step 770, and optionally building an Explanation of Benefits, step 775. In one embodiment, the details of the transaction, with or without details of the transaction to comply with confidentiality obligations, are stored in the TPA layer or a related database, step 455. In addition, or instead, the TPA layer may instruct or cause a responsible bank to make any required payments to the provider (not shown). As above, status tables are updated, step 440, data is stored in a central database, step 760, and bank documents or transactions are initialized (not shown) and associated with the unique identifier.

When the layer receives confirmation that the bank payments are made, the method may cause the layer to build an EOB, step 775. After the EOB is built, it may be sent to the document management, step 780. Similarly, it may be saved to the TPA layer or a related database, step 455 and/or to a central database, step 760. After the EOB is built, the status table is again updated, step 440.

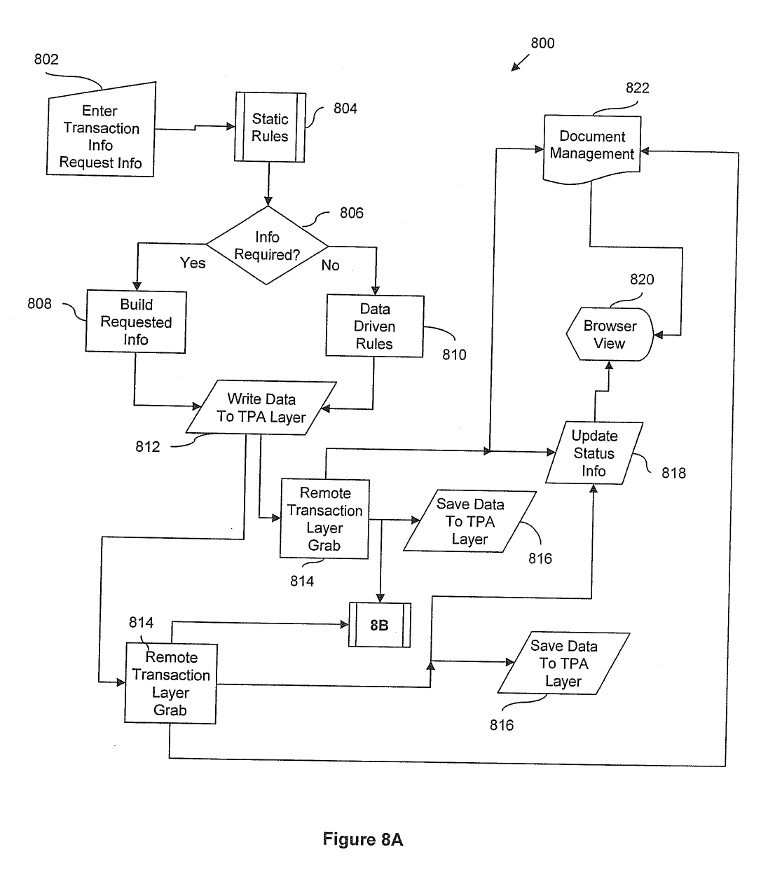

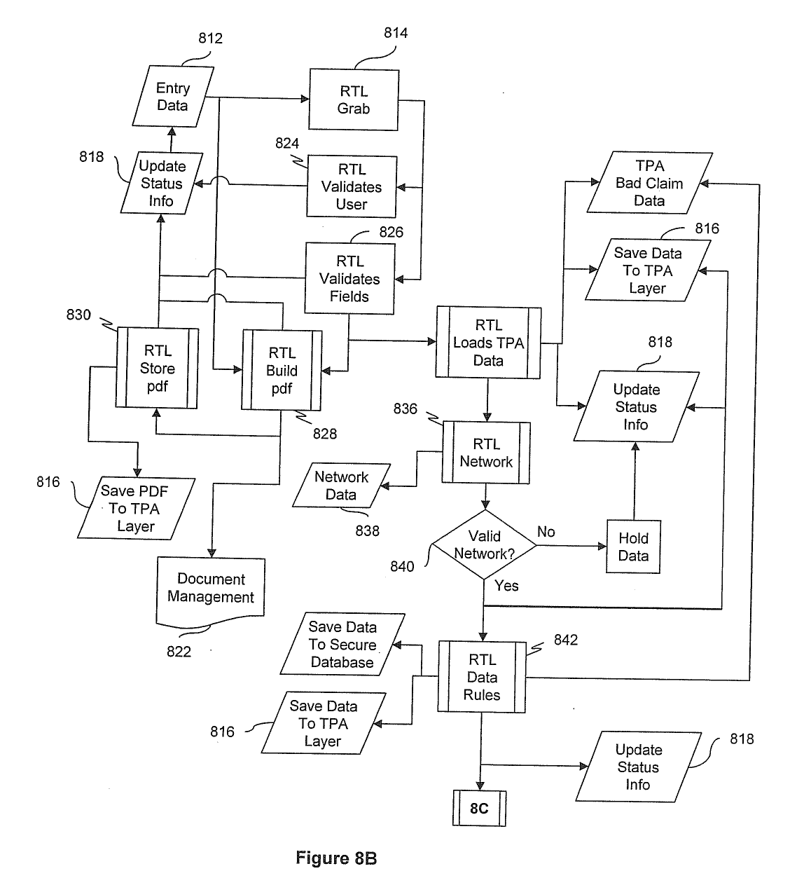

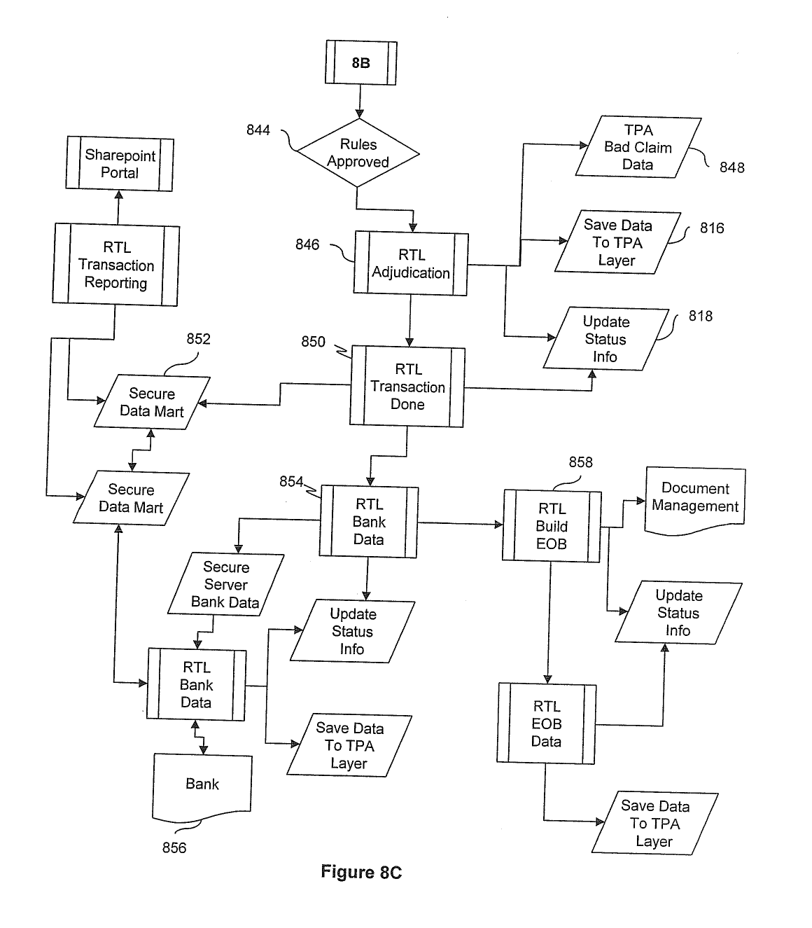

While FIGS. 4, 7A, and 7B illustrate a simplified method for a system including a single TPA layer, it should be understood that the method may be employed concurrently by a plurality of TPA layers. FIGS. 8A-8C illustrate a more complex method employing two TPA layers. The method may be similarly modified to employ three or more TPA layers.

With reference now to FIG. 8, an exemplary method 800 may begin by a user entering a transaction, step 802. The transaction can include a claim, a referral, a pre-certification, a pre-authorization, a referral, an informational request via an explanation of benefits (EOB), a report, a Health Care Financing Administration (HCFA) form, and the like. The user can be a health care provider such as a hospital, clinic, surgery center or the like. Also the user may be a member, such as a Third Party Administrator (TPA), Health Maintenance Organization (HMO), Preferred Provider Organization (PPO), Exclusive Provider Organization (EPO) and other types of health plans.

Once the transaction is entered, a static rule or group of rules may be applied, step 804, to permit or prevent various downstream options based on the transaction entered, or based on data corresponding to the transaction. For example, if a claim is entered for a male, no female related codes will appear throughout the process. Other rule implementations include checking eligibility rules, date rules, Coordination of Benefits (COB), and the like. Further, if a unique transaction identifier is not yet established, one of the rules may assign such an identifier at this point for transaction tracking throughout the system.

At step 806, the method may decide if further information is requested. If so, the method may build a request information, step 808. If not, the method may apply data driven rules, step 810. For example, is the transaction a client, a pre-authorization, a pre-certification, a request for a report, or a request for an EOB. After the build or the rules are applied, data may be written to the database, step 812.

A remote transaction layer (RTL) may receive appropriate data, step 814. The data may be pulled from database after step 816, or it may be pushed out of the database after step 812, or it may proceed directly to the layer without an intermediate stop. Typically, the entry data stored at step 812 may segregated by, and accessible only to, for example, intended TPA's. Once obtained however, at step 814, by the intended party, the intended TPA to continue the example, the data may be stored in a dedicated TPA database, at step 816.

Once the data is obtained by the transaction or TPA layer, the status of the transaction may be stored for later access, audit, and/or analysis, step 818. As will be further explained below, in one embodiment, the status of the transaction may be tracked through the life of the transaction and/or throughout the method and system by a unique identifier established upon transaction entry, at step 802, or shortly thereafter. The status information at step 818 may be viewed by authenticated persons, at step 820 and documents, preferably electronic documents, relating to the transaction may be viewed and/or manipulated, if permitted, at step 822.

The transaction or TPA layer, may include additional functionality to validate a transaction, as shown in FIG. 8B. Additional functionality may include validation that a valid user that wrote the claim, step 824. For example, if an attempt was made to submit a claim without knowing a valid code identifying a valid user permitted to enter transactions such as claims, the method would reject the transaction at this point. Additionally, or alternatively, the added functionality may include verification that all proper fields are populated, step 826. For example, a transaction may be considered invalid if any required field is missing data, or contains corrupt data.

The method may then produce desired documents relating to the verified data. For example the method may build or generate the HCFA PDF forms, step 828. After the PDF form is generated, it may then be written into the database and put into a binary format in the database which may be encrypted, step 830. The document may also be stored in the front end document management database, step 822 and/or stored in a backend database.

The method may also update the status table, step 818, after each step or after several steps. For example, as the transaction or TPA layer grabs the data, step 814, it writes to the status table, step 818. As it validates the user, step 824, it writes to the status table, step 818. As it validates all required fields, step 826, it writes to the status table, step 818. As it writes to the TPA, it writes to the status table. As it builds the PDF, step 828, it writes to the status table, step 818. As it stores the PDF, step 830, it writes to the status table, step 818. As it writes to the data and the document management, step 822, it stores to the status table, step 818.

The method then interfaces with particular rules, data, and procedures established by the TPA, step 836. For example, in a PPO network, the layer is actually in communication with the network's data, step 838. The communication may involve certain acceptable charges for a procedure associated with the transaction where the charges, the procedure or both may be further associated with the unique transaction identifier. In other words, the method may obtain the charge for the procedure, or if the network already has a discount arrangement for that procedure or with the associated provider.

The method may then confirm or deny that the transaction is covered or supported by the particular network, step 840. If the network is not valid or does not cover the transaction, the status table is updated, step 818, and the method stops (not shown). Alternately, or if the transaction is covered, the method may continue and the layer accesses the data rules, step 842.

The data rules may include claim data, eligibility data, subrogation triggers, and items that may require manual interaction. For example, in the case of an automobile accident claim, certain official reports may be required. The method may then update the transaction database, step 816, and the status table, step 818. The method may proceed to layer adjudication, as illustrated in FIG. 8C.

With respect now to FIG. 8C, after rule approval, step 844, the method proceeds to layer adjudication, step 846, for final adjudication of the transaction. Adjudication may be the calculation of what payment, if any, is required from each of the potentially responsible payers. In other words, what is the plan provider responsible for, what is the employee responsible for, what is denied, what co-pay is required, what deductible applies, and the like. What dollar amount will be payable to the provider, and how does the schedule of benefits apply to the transaction.

In one embodiment, a schedule of benefits is available to the provider to enable the provider to know in an office visit setting if a co-pay, as an example, is due, or if full coverage, or a deductible applies and so forth. The TPA data, step 816, informs the provider and the covered user, who will be responsible for what costs throughout that transaction. The adjudication, step 846, may update the TPA data, step 816, the status table, step 818, and generate, where applicable, bad claim data. As above, all data may be associated with a unique transaction identifier.

With the transaction fees known, the method then may permit the layer to complete the transaction, step 850. In one embodiment, the details of the transaction, with or without details of the transaction to comply with confidentiality obligations, are stored in a database, step 852. In addition, or instead, the method proceeds to the layer instructing a responsible bank to make any required payments to the provider, step 854. As above, status tables are updated, step 818, and bank documents, or transactions are initialized, step 856. Also, when the layer receives confirmation that the bank payments are made, the method may cause the layer to build an EOB, step 858.

In the above-described illustrated embodiment, the TPA layer multitasks and perform several steps concurrently. Alternatively, the method may be performed linearly. It should be understood that many of the steps are optional. The nature of the transaction will dictate whether steps are required. For example, not all transactions will require the generation of a pdf faun. Similarly, if the transaction is an information request for an Explanation of Benefits, there may be no need for claim adjudication or payment.

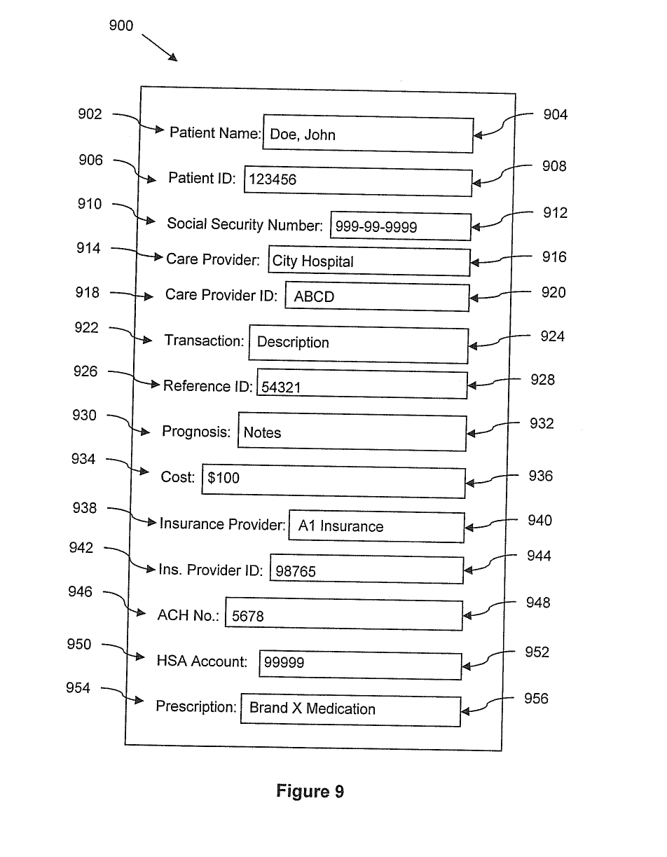

FIG. 9 illustrates data entered in an exemplary transaction 900. It should be understood that FIG. 9 is for illustrative purposes only, and may not represent the data entered in an actual health care transaction. In the illustrated embodiment, a patient name field 902 has an associated patient name 904, a patient ID field 906 has an associated patient identifier 908, a patient social security number field 910 has an associated patient social security number 912, a care provider field 914 has an associated care provider name 916, a care provider ID field 918 has an associated care provider ID 920, a transaction field 922 has an associated transaction description 924, a reference ID field 926 has an associated reference ID 928, a prognosis field 930 has an associated prognosis 932, a cost field 934 has an associated cost 936, an insurance provider field 938 has an associated insurance provider 940, an insurance provider ID field 942 has an associated insurance provider ID 944, an ACH Number field 946 has an associated ACH Number 948, an HSA account field 950 has an associated HSA account 952 and a prescription field 954 has an associated prescription 956. Only that data needed and permitted to adjudicate and pay a claim may be provided to downstream parties. In one embodiment, the reference ID 928 functions as a unique transaction identifier and stays with the various other components throughout all transaction processing and tracking.

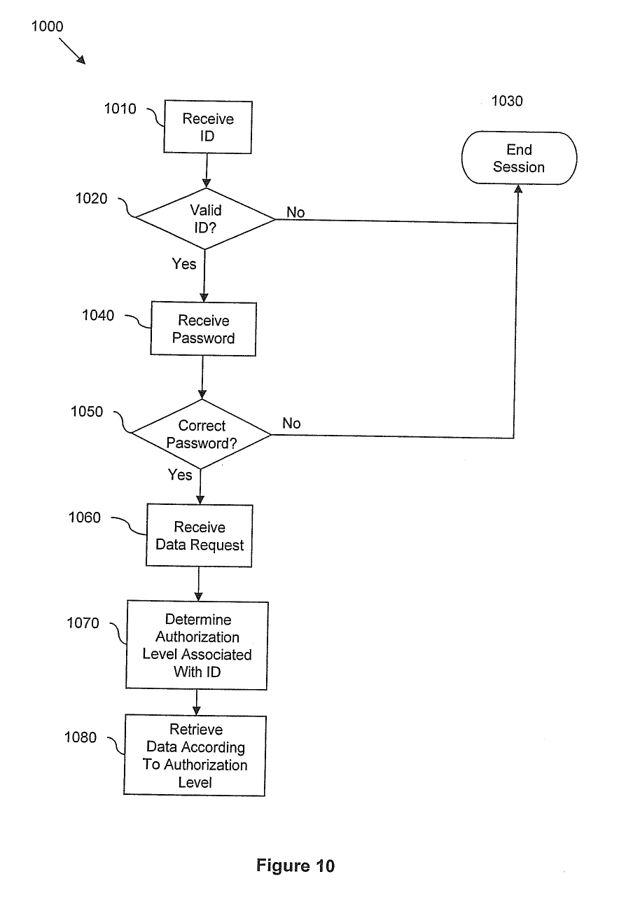

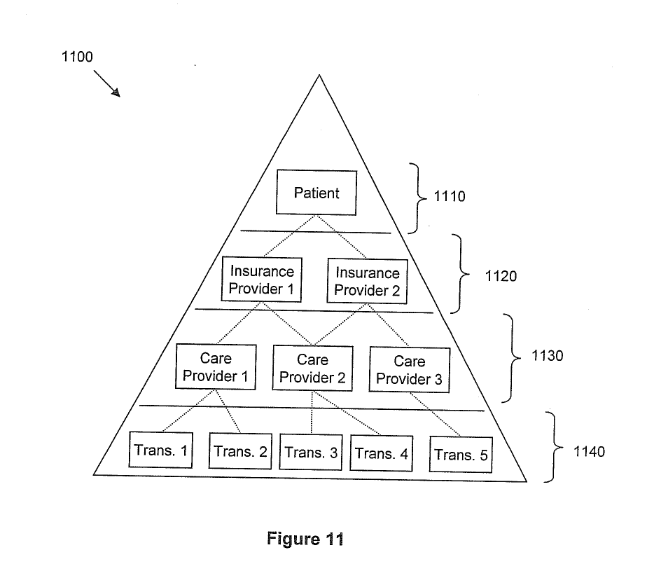

FIG. 10 illustrates one embodiment of a method for tracking health care transaction data 1000. The method begins with the receipt of an ID, step 1010. The ID may be a patient ID, a patient social security number, a care provider ID, an insurance provider ID, or any other such ID. After receiving an ID, the system validates the ID, step 1020. If the ID does not match a stored ID, the ID is invalid and the session ends, step 1030. After the ID is validated, the user enters a password or a PIN, step 1040. The system then determines if the password or PIN matches a stored password or PIN associated with the validated ID, step 1050. If the password or PIN do not match the stored password or PIN, the session ends, step 1030.

In an alternative embodiment (not shown), a user enters an ID and a password or PIN at the same time, rather than in separate steps. In another alternative embodiment (not shown), the user does not enter a password but the user's authority and identity is otherwise confirmed.

After user validation, the system receives a data request, step 1060. The data request identifies a data field and an identifier within the data field. For example, in one embodiment, the data request includes a patient number ID field 906 and a patient number “123456” 908. In an alternative embodiment (not shown), a separate data request is not made and instead a search is immediately made for transactions related to the validated ID.

After receiving the data request, an authorization level is determined based on the validated ID, step 1070. The system then searches for and retrieves data, step 1080, based on the data request and the authorization level.

An authorization level may be determined according to a hierarchy 1100, as illustrated in FIG. 11. In the illustrated hierarchy, a user who enters the patient ID has the highest authorization level 1110 and may view all transactions associated with the patient ID. For example, even if the patient was covered by multiple insurance providers and received care at multiple care providers, if the user provides a patient ID, the user may view all transactions, regardless of who provided insurance and who provided care. In other words, the patient ID provides allows the user access to any of the data within the illustrated pyramid that the user is authorized to view.

In addition to requiring a patient ID, additional authorization may be required to view confidential fields within a transaction. For example, a doctor may have access to a patient ID number, and may access the system to view the patients medical history, including a description of transactions, prognoses, and prescriptions. However, the doctor may be prohibited from viewing billing information. Similarly, an insurance provider may have access to a patient ID number, but may be prohibited from viewing information protected by doctor-patient confidentiality.

With continued reference to FIG. 11, a user supplying an insurance provider ID is at a secondary authorization level 1120, and may view transactions paid for by that insurance provider. Similarly, a user supplying a care provider ID is at a lower authorization level 1130, and may view transactions that were performed by that care provider. Finally, the lowest authorization level is the transaction authorization level 1140. By supplying a transaction number, a user may only view information from the selected transaction. In all cases, the user ID provides the user with access to all information that the user is authorized to view within the illustrated pyramid.

While the systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on provided herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Similarly, when the applicants intend to indicate “one and only one” of A, B, or C, the applicants will employ the phrase “one and only one”. Thus, use of the term “or” herein is the inclusive, and not the exclusive use. See, Bryan A. Garner, A Dictionary of Modern Legal Usage 624 (2d. Ed. 1995).

What is claimed is:

1. Computer implemented steps for processing a health care transaction, comprising:
receiving data related to a health care transaction, including a unique identifier for uniquely identifying and tracking the health care transaction;
applying rules based on characteristics of the received data, where application of the rules eliminates downstream options;
building a transaction based in part on the received data and on the applied rules;
storing the transaction;
updating transaction status information;
sending the transaction to a transaction layer for at least one of form generation, claim adjudication, facilitation of claim payment, and an explanation of benefits;
receiving processed data from the transaction layer; and
storing the processed data.

2. The computer implemented steps of claim 1, further comprising a step of generating a unique identifier associated with the health care transaction.

3. The computer implemented steps of claim 1, further comprising the step of selecting a form type according to the applied rule.

4. The computer implemented steps of claim 3, further comprising steps of sending a form request to the transaction layer and receiving a completed form from the transaction layer.

5. The computer implemented steps of claim 3, further comprising a step of determining if additional information is needed to generate the form.

6. The computer implemented steps of claim 5, wherein the step of determining if additional information is needed is performed according to the applied rule.

7. The computer implemented steps of claim 3, wherein the step of adjudicating the transaction includes a step of transmitting the generated form to a predetermined authority.

8. The computer implemented steps of claim 1, further comprising a step of storing transaction status information.

9. The computer implemented steps of claim 1, wherein the health care transaction is one of a claim, a referral, a pre-certification, a pre-authorization, an information request via an explanation of benefits, a report, a Health Care Financing Administration form.

10. A method for processing health care transaction data comprising the steps of:
receiving health care transaction data, wherein the health care transaction data includes a plurality of fields and at least one unique identifier for uniquely identifying and tracking a health care transaction associated with the health care transaction data;
storing the health care transaction data;
receiving a search query including at least one identifier and at least one selected field;
validating the identifier;
determining an authorization level based at least in part on the identifier, wherein the authorization level is associated with a plurality of fields of a health care transaction;
searching a database of health care transaction, each health care transaction having a plurality of fields;
identifying at least one health care transaction having the identifier in the selected fields; and
retrieving all fields associated with the authorization level from at least one health care transaction.

11. The method of claim 10, wherein the health care transaction is one of a claim, a referral, a pre-certification, a pre-authorization, an information request via an explanation of benefits, a report, and a Health Care Financing Administration form.

12. The method of claim 10, wherein the step of identifying at least one health care transaction includes identifying a plurality of health care transactions.

13. The method of claim 10, wherein the identifier includes a patient identifier and the authorization level is associated with all fields from all health care transactions related to the patient identifier.

14. The method of claim 10, wherein the identifier includes an insurance provider identifier and the authorization level is associated with fields according to doctor-patient confidentiality rules.

15. The method of claim 10, wherein the identifier includes a care provider identifier.

16. A health care processing system comprising a transaction layer having:
data receiving logic configured to receive data corresponding to a remotely entered health care transaction, wherein the data includes at least one unique identifier for uniquely identifying and tracking the health care transaction;
validation logic configured to validate the data received by the data receiving logic;
form identification logic configured to identify at least one form needed to process the health care transaction;
form generation logic configured to generate the identified form according to the data received by the data receiving logic;
transaction adjudicating logic configured to adjudicate a transaction; and
payment coordination logic configured to coordinate a payment from a third party payor.

17. The health care processing system of claim 16, wherein the validation logic is configured to validate the received data by authenticating a source of data.

18. The health care processing system of claim 17, wherein the source of the data is a remote user.

19. The health care processing system of claim 16, further comprising transmission logic configured to transmit the entered data to a requesting user upon receipt of a valid authorization code and a tag identifying the data.

20. The health care processing system of claim 16, wherein the adjudication logic transmits the generated form to a predetermined authority and waits for a response.
